(19) United States
(12) Patent Application Publication
(10) Pub. No.: US 2026/0251545 A1
(43) Pub. Date: Aug. 27, 2026

(54) NEUTRON REFLECTIVITY-RHEOLOGY SAMPLE ENVIRONMENT FOR INVESTIGATING MATERIALS AT AIR-LIQUID AND LIQUID-LIQUID INTERFACES AND METHODS OF USE THEREOF

(71) Applicant: STF Technologies LLC, Newark, DE (US)

(72) Inventors: Richard DOMBROWSKI, Lutherville, MD (US); Norman WAGNER, Newark, DE (US); Benjamin THOMPSON, Elkton, MD (US); Mason KERESTY, Middletown, DE (US); Hannah NEVEL, Newark, DE (US)

(21) Appl. No.: 18/872,554

(22) PCT Filed: Jun. 5, 2023
(86) PCT No.: PCT/US2023/024481

§ 371 Date: Dec. 6, 2024

Related U.S. Application Data
(60) Provisional application No. 63/349,961, filed on Jun. 7, 2022.

(51) Int. Cl. G01N 13/02; G01N 11/00; G01N 11/16

(52) U.S. Cl. CPC G01N 13/02; G01N 11/16; G01N 2011/0046; G01N 2013/0291

(57) ABSTRACT

The present invention combines surface rheology with advanced surface metrology including neutron and X-ray reflectivity and grazing incidence scattering to create a unique sample environment for material investigation. The instruments disclosed herein are configured for independent control of the compression/expansion, shear deformation, and/or oscillatory deformation of a sample by using a quadrangular design with either a four-motor system or a two-motor system. Through combining precise control of interfacial deformation with surface pressure and reflectivity measurements (and optical and particle tracking measurements), complex interfacial systems can be fully characterized on all length scales (i.e., molecular, nano, micro, macro) and used alongside simultaneous surface pressure measurements to develop novel structure-property relationships. Also described herein are methods of using the sample environments and systems for analyzing the interfacial rheology of air-liquid or liquid-liquid interfaces.

### CROSS-REFERENCE TO RELATED APPLICATIONS

This application claims the benefit of the filing date of U.S. Provisional Application No. 63/349,961, filed Jun. 7, 2022, the entire contents of which is incorporated by reference herein.

### FIELD OF THE INVENTION

The present invention relates to devices and systems for the analysis of materials at the air-liquid and liquid-liquid interfaces. In particular, sample environment chambers are disclosed capable of simultaneous measurement of surface moduli, shear and bulk, and molecular structure across the plane and/or through the interface of the interfacial system.

### BACKGROUND OF THE INVENTION

An understanding of rheology, which is the study of deformation and flow of matter, especially the non-Newtonian flow of liquids and the plastic flow of solids, is essential for predicting the flow of fluids, including biological materials, and other materials and for developing and improving a wide range of products, including many consumer products. Rheologically complex materials, such as those with non-Newtonian flow characteristics, can change viscosity and strength upon the application of shear stress. Indeed, soft materials, metals, plastics, nanocomposites, self-assembled nanostructured materials, and many consumer products, such as detergents, skin creams, foods, and emulsions are often processed with a thermal and shear history to create an important structure.

In addition to bulk materials, many material interfaces may also exhibit rheologically complex characteristics. Interfaces are essential components of biological systems, food products, and various consumer products. Biological systems where interfaces are essential components include, but are not limited to, the alveoli in the lungs and the liquid membrane packaging of the SARS-CoV-2 virus mRNA. Moreover, it has recently been proposed that the molecular structure and rheology of the mucus-laden air-water interface of the lungs is important for the aerosol transmission of the Covid-19 disease. Interfaces are also important for biopharmaceutical processing, and in many consumer products, such as milk, topical creams and lotions, and other products. For example, utilization of interfacial systems may be used to impart a desired “feel” to certain topical skin products upon spreading.

Importantly, the air-fluid and fluid-fluid interfaces of many natural and manmade systems are rheologically complex, such that the molecular structure and properties of the interface depend on the mechanical deformation history of the interface. However, while characterization techniques for some structure-property relationships have been defined for bulk complex fluids and soft materials, such techniques are ineffective or otherwise insufficient for analysis of interfacial systems. For one, current methods lack the capability to simultaneously probe interfacial microstructure with the response to rheological deformation.

For instance, neutron reflectivity has been successful in elucidating microstructure, and even structural orientation, of molecular structures at air-liquid interfaces. However, the combination of neutron reflectivity with complimentary characterization techniques, such as interfacial rheology, has not been well-established. Other instruments existing in the art for interfacial rheology can perform pure dilation or compression, but lack pure shear abilities or the ability to perform both dilation and shear in one geometry. Indeed, the lack of suitable characterization techniques hinder the advancement for proper investigation of interfacial rheological behaviors and their attributed structural formation.

Therefore, a need exists in the art for an interfacial rheological sample environment that allows for independent control of shear and dilation/compression deformations at the air-liquid and liquid-liquid interfaces. Additionally, a need exists for enabling simultaneous mechanical, optical and neutron reflectivity measurements of the microstructure of complex interfaces. Further control of sample environmental conditions including thermodynamic state, and integrated control of deformation history and neutron scattering data acquisition are further needs in the art.

### SUMMARY OF THE INVENTION

Described herein are novel sample environments applicable to the investigation of a broad range of soft matter and biological materials at the air-liquid and liquid-liquid interfaces. The present invention combines surface rheology with advanced surface metrology, including neutron and X-ray reflectivity and grazing incidence scattering to create a unique sample environment for material investigation. This invention directly addresses the above-described need in the art for simultaneous measurement of interfacial stresses and microstructure across a broad range of material properties and environmental conditions. The instruments disclosed herein can independently control the compression/dilation and shear deformation of the sample by using a quadrangular design with either a quad-motor system or a dual-motor system. Through combining precise control of interfacial deformation with surface pressure and reflectivity measurements (and optical and particle tracking measurements), complex interfacial systems can be fully characterized on all length scales (i.e., molecular, nano, micro, and macro) and used alongside simultaneous surface pressure measurements to develop novel structure-property relationships.

The invention generally includes a sample environment chamber in which is disposed an interfacial deformation assembly that includes a radial sample trough and elastic deformation barrier that is manipulated by four deformation arms in a quadrangular orientation and controlled by a motor-controlled actuator assembly. In preferred embodiments, the deformation arms are moved linearly by a dual-motor system that utilizes ball screws in the actuator arm components. The elastic deformation barrier may comprise a fluoroelastomeric material for neutron scattering analysis. The invention will also comprise a central processing unit for integrating the motor-controlled actuator assembly, precise temperature and humidity controls, and each of the rheology and/or advanced surface metrology instruments interfaced with the sample environment chamber.

In one aspect of the invention, disclosed herein is an interfacial rheometer device that includes a sample environment chamber with an interior, a baseplate, and at least two radiation beam windows on opposing side walls for receiving a beam of radiation. In this aspect, the interfacial rheometer additionally includes an interfacial deformation assembly that comprises a radial sample trough with a reservoir for receiving an air-liquid or liquid-liquid interfacial sample, an elastic deformation barrier, and at least four deformation arms, each having a cylindrical finger. The elastic deformation barrier is disposed around the cylindrical fingers of each of the four deformation arms in a quadrangular arrangement, and the interfacial deformation assembly is disposed within the interior of the sample environment chamber. Further, the interfacial rheometer device may include a motor-controlled actuator assembly with four actuator arms, each of which includes a ball screw and is attached to a deformation arm and configured for moving the actuator arm in a linear direction; and at least two motors, wherein each motor is in communication with at least one actuator arm and configured for rotating the ball screw of the actuator arm. In this aspect, the motor-controlled actuator assembly is controlled by a central processing unit. When in operation, the elastic deformation barrier is disposed within the reservoir of the radial sample trough and configured for applying dilatational stress, compression stress, shear stress, or any combination thereof to the interfacial sample in response to the motor-controlled actuator assembly. In some embodiments, the elastic deformation barrier is a fluoroelastomer.

In an embodiment, the motor-controlled actuator assembly is a dual-motor system that includes two motors. Further, the actuator arms are coupled in two pairs, with the actuator arms of each pair arranged in opposing orientations, and one of each pair comprising a ball screw with reverse threads. In this embodiment, each pair of actuator arms is connected to a motor. In some embodiments, each motor is a servo motor. In other embodiments, each motor is coupled to a planetary gearbox.

In another embodiment, the elastic deformation barrier of the interfacial rheometer device provides a workable area with the range from about 3,500 mm² to about 12,100 mm². Further, in certain designs, the elastic deformation barrier is capable of deforming the interfacial sample at a rate of between about 1.02 mm²·s⁻¹ to about 146,500 mm²·s⁻¹. However, it is preferable that the recommended deformation rate is between about 1.02 mm²·s⁻¹ to about 10 mm²·s⁻¹. In some embodiments, the elastic deformation barrier applies strain to the interfacial sample at a strain rate from about 0.00015 s⁻¹ to about 1.6 s⁻¹. In other embodiments, the elastic deformation barrier comprises at least about 60% fluorine. In still other embodiments, the elastic deformation barrier compresses or dilates the interfacial sample at a constant rate of area change or shears the interfacial sample while maintaining a constant surface area.

In another embodiment, the elastic deformation barrier: (i) compresses or dilates the interfacial sample at a regular oscillatory deformation; or (ii) applies an oscillatory shear to the interfacial sample while maintaining a constant surface area. The oscillatory deformation or oscillatory shear includes, but is not limited to, sinusoidal, triangle wave, square wave, and/or superposition of multiple frequencies. In yet other embodiments, the oscillatory deformation or oscillatory shear comprises a frequency in the range from about 0.001 Hz to about 1000 Hz, and, the elastic deformation barrier applies a strain having a strain amplitude in the range from about 0.001 strain % to about 1,000 strain %. In preferred embodiments, the oscillatory deformation or oscillatory shear comprises a frequency in the range from about 0.01 Hz to about 100 Hz. In other embodiments, strain amplitude is in the range from about 0.1 strain % to about 100 strain %. In still other embodiments, the elastic deformation barrier applies a deformation comprising the superposition of linear motion, oscillatory motion, dilational deformation, shearing, or any combination thereof.

Some embodiments of the interfacial rheometer devices will include a vertical actuation stage configured to move the sample trough along the Z-axis in response to the central processing unit. Other embodiments of the invention will integrate equipment for analyzing interfacial samples, such as, but not limited to, a Brewster angle microscope, a particle image velocimetry camera, and/or a tensiometer balance and Wilhelmy plate. In each case, the equipment may be disposed within the interior of the sample environment chamber and in communication with the central processing unit. In other embodiments, the interfacial rheometer device will interface with a neutron reflectometry system configured to direct a neutron radiation beam to the interfacial sample and/or an X-ray system configured to direct X-ray radiation to the interfacial sample. In these embodiments, the two radiation beam windows of the interfacial rheometer device may be aligned with the neutron radiation beam path or the X-ray radiation beam path, respectively. In an embodiment, the radiation beam windows comprise titanium, beryllium-quartz, aluminum, poly(4,4′-oxydiphenylene-pyromellitimide), or a combination thereof.

In another embodiment, the interfacial rheometer device includes a temperature control device configured to maintain a temperature of the interior of the sample environment chamber to between about 0 degrees C. to about 100 degrees C. in response to the central processing unit and/or a humidity control device configured to maintain a humidity of the interior of the sample environment chamber to between about 0% relative humidity to about 100% relative humidity in response to the central processing unit. In yet another embodiment, the radial sample trough is disposed on a thermal circulator. The interfacial rheometer device may also include a vibration isolation stage disposed underneath the sample environment chamber and configured to isolate the sample from environmental vibrations.

Another aspect of the invention features a method of analyzing an interfacial sample material that includes the steps of providing an interfacial rheometer device as described above, disposing an interfacial sample in the reservoir of the radial sample trough, contacting the interfacial sample with the elastic deformation barrier, applying a strain to the interfacial sample, and measuring one or more rheological characteristics. In some embodiments, the interfacial sample is an air-liquid or liquid-liquid sample. The measuring step may be performed using one or more of a Brewster angle microscope to visualize the interfacial structure, a particle image velocimetry camera in combination with spreading particles for recording the particle movement during the application of stress to the interfacial structure, a Wilhelmy plate to measure surface tension of the interfacial sample, a neutron reflectometry system to neutron reflection or GISANS, an X-ray system to measure small angle X-ray reflection or GISAXS, or any combination thereof.

Other features and advantages of the invention will be apparent by reference to the drawings, detailed description, and examples that follow.

### BRIEF DESCRIPTION OF THE DRAWINGS

FIG. 1 are diagrams depicting the dilation/compression and planar shear deformations. Panel A is a diagram of the dilation/compression deformation. The dotted box indicates the original position of the elastic deformation barrier, whereas the solid box indicates the final geometry of the elastic deformation barrier. The arrows indicate the direction of the elastic deformation barrier movement as compression stress is being applied to the interfacial system. Panel B are diagrams of the planar shear stretch deformation. The dotted box indicates the original position of the elastic deformation barrier, whereas the solid quadrangle indicates the final geometry of the elastic deformation barrier. The arrows indicate the direction of the elastic deformation barrier movement as shear stress is being applied to the interfacial system. The line in the center indicates the position of the Wilhelmy plate. The shear forward and backward motions are shown in relation to the position of the Wilhelmy plate. Negative strain (−γ) is denoted when the Wilhelmy plate is oriented parallel to the extensional axes, whereas position strain (+γ) is denoted with the Wilhelmy plate is oriented perpendicular to the extensional axes.

FIG. 2A is a perspective view of a radial sample trough.

FIG. 2B is a cross-sectional view of a radial sample trough.

FIG. 2C is a perspective view of an elastic deformation barrier.

FIG. 2D is a perspective view of an exemplary deformation arm.

FIG. 3 is a front perspective view of an exemplary sample environment chamber with a quad-motor system.

FIG. 4A is a front perspective view of an exemplary sample environment chamber with a dual-motor system.

FIG. 4B is a cross-sectional view of an exemplary sample environment chamber with a dual-motor system.

FIG. 5 is a top diagrammatic view of the radial sample trough and deformation arms.

FIG. 6 is an exploded view of the vertical actuation stage assembly.

FIG. 7 are Brewster angle microscopy images of stearic acid on a water subphase. The left image was taken at a surface pressure of 2 mN·m⁻¹, and the right image was taken at a surface pressure of 40 mN·m⁻¹. The white regions of the images represent structures on the interface, whereas the black regions reflect areas where light is transmitted through the interface, i.e., no particles/molecules present.

FIG. 8 are still images taken from video footage of a PIV camera recording sulfur particles on top of a stearic acid interface on an Al(NO)₃ subphase. The two pictures on the left depict compression from the original geometry (left) to a smaller area (left, center). The two pictures on the right depict shear stress from the original geometry (right, center) to the sheared geometry (right). The specs are the sulfur particles.

### DETAILED DESCRIPTION OF THE INVENTION

Described herein are novel designs for a sample environment chamber suitable for taking enhanced rheological measurements at the air-liquid or liquid-liquid interfaces simultaneously with advance surface metrology measurements, such as neutron reflectivity and scattering. For the first time, integration of multiple rheological and metrology investigative tools and the simultaneous measurement of interfacial stresses and microstructure across a broad range of material properties and environmental conditions in a single environment chamber is possible. The invention includes a sample environment chamber in which is disposed an interfacial deformation assembly that is controlled by a quad-motor or dual-motor controlled actuator assembly.

The interfacial deformation assembly includes a radial sample trough (e.g., a radial Langmuir trough), an elastic deformation barrier, and four deformation arms. The elastic deformation barrier is disposed around cylindrical, finger-like projections on each of the deformation arms such that the combination of elastic deformation barrier and the deformation arms is arranged in a quadrangular orientation. The radial sample trough includes a sample reservoir that receives an interfacial sample to be investigated. The user first disposes the air/liquid subphase into the reservoir and then dispenses the liquid monolayer onto the subphase to form the interfacial system. Alternatively, for soluble systems, the adsorbing material can be introduced into the liquid subphase and adsorption onto the air/liquid interface measured. The elastic deformation barrier is inserted into the interfacial system to create the workable area or area of interest, it being understood that the liquid monolayer can also be added to the system after insertion of the elastic deformation barrier by adding the monolayer on top of the subphase within the interior of the elastic deformation barrier for insoluble monolayers, or introduced directly into the subphase for soluble systems. The workable area will have an original geometry that is altered by manipulation of the elastic deformation barrier to apply a dilation/compression and/or shear stress to the interfacial system. As this occurs, various rheological and/or surface metrology measurement tools integrated into the system can be used to take readings/images of the interfacial system over time to create the deformation history profile. A preferred embodiment for measurements of interfacial stress is a Wilhelmy plate, although other methods, such as microtensiometers may be used.

The manipulation of the elastic deformation barrier is performed by the motor-controlled actuator system. In a preferred embodiment, the motor-controlled actuator system includes two pairs of linear actuator arms with each actuator arm configured to move a stage or carriage in the linear direction (i.e., forward or backwards) via a ball screw. Two actuator arms are positioned in opposite or mirrored orientations and incorporate reverse threads such that the two stages or carriages are moved in opposing directions. Each pair of actuator arms is rotated by a motor, which, preferably is a servo motor and gearbox. The motor-controlled actuator system is itself controlled by a central processing unit that is user operated or programmable by way of a graphic user interface. The stages or carriages on each of the actuator arms is attached to the deformation arm and moves the deformation arm to cause the elastic deformation barrier to apply dilation/compress and/or shear stress on the interfacial system as will be explained in further detail below. In a preferred embodiment, the motor-controlled actuator system is a dual-motor system and positioned underneath the sample environment chamber and connected to the deformation arms through slots in the baseplate of the sample environment chamber.

As the elastic deformation barrier applies dilation/compression and/or shear stress to the interfacial system, rheological and/or surface metrology measurements can be carried out in real time including, but not limited to, Brewster angle microscopy, surface tension (e.g., via a tensiometer such as a Wilhelmy plate), particle image velocimetry, small-angle neutron scattering, neutron reflectivity, grazing-incidence small-angle neutron scattering, small-angle X-ray scattering, X-ray reflectivity, grazing-incidence small-angle X-ray scattering, and the like. Moreover, the present invention may include precise temperature and humidity control devices that are integrated into the system to enable the user to maintain the internal chamber temperature and/or humidity.

The devices and methods of use thereof will now be described in more detail.

### Definitions

Unless defined otherwise, all technical and scientific terms used herein have the same meaning as those commonly understood by one of ordinary skill in the art to which this invention belongs. Standard techniques are used unless otherwise specified. Although methods and materials similar or equivalent to those described herein can be used in the practice or testing of the present disclosure, suitable methods and materials are described below. The materials, methods and examples are illustrative only, and are not intended to be limiting. All publications, patents and other documents mentioned herein are incorporated by reference in their entirety.

Ranges, if used, are used as shorthand to avoid having to list and describe each and every value within the range. Any value within the range can be selected, where appropriate, as the upper value, lower value, or the terminus of the range.

As used herein, the singular forms “a,” “an,” and “the” include the plural referents unless the context clearly indicates otherwise. Likewise, the terms “include”, “including”, and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The term “about” refers to the variation in the numerical value of a measurement, e.g., diameter, weight, length, temperature, moisture content, volume, angle degrees, etc., due to typical error rates of the device used to obtain that measure. In one embodiment, the term “about” means within 5% of the reported numerical value, preferably, the term “about” means within 3% of the reported numerical value.

The term “comprising” is intended to include embodiments encompassed by the terms “consisting essentially of” and “consisting of.” Similarly, the term “consisting essentially of” is intended to include embodiments encompassed by the term “consisting of.”

The term “dilatational stress” or “dilation stress” are used interchangeably herein and refer to the stress that acts to change the area of the interface. “Dilation” may refer to the expansion of the area in which the interface is disposed, whereas “compression” may refer to the reduction of the area in which the interface is disposed. “Dilatation” is a type of isotropic stress.

The term “isotropic stress” as used herein refers to a type of stress that occurs when the material or interface is put under uniform or isotropic compression or expansion. An “isotropic stress” can be applied to an interface to change the area, but does not change the shape.

The term “deviatoric stress” as used herein refers to a type of stress that acts to change the shape, but not area, of a material or interface.

The terms “grazing-incidence small-angle neutron scattering” or “GISANS” are used interchangeably herein to refer to a radiation scattering technique used to study surface structures that utilizes accelerated neutrons as the source of radiation. “GISANS” combines the accessible length scales of SANS (defined below) and the surface sensitivity of grazing incidence diffractions.

The terms “grazing-incidence small-angle X-ray scattering” or “GISAXS” are used interchangeably herein to refer to a scattering technique that utilizes X-rays to study surface structure.

The term “reflectivity” as used herein refers to the reflection of a radiation source, such as neutrons, light, or X-rays, from a surface or interface in order to study the structure of the surface or interface.

The term “rheology” as used herein refers to the deformation and flow of matter.

The term “scattering” as used herein refers to a general physical process where some forms of radiation, such as light, neutrons, or X-rays, are forced to deviate from a straight trajectory by one or more paths due to localized non-uniformities in the medium through which they pass.

The term “shear strain” as used herein refers to the length of deformation of a material divided by the perpendicular length in the plane of the force applied.

The term “shear stress” as used herein refers to a component of stress that is co-planar with a material cross section.

The terms “small-angle neutron scattering” or “SANS” are used interchangeably herein to refer to a scattering technique using accelerated neutrons as the source of radiation. Preferably, the angle of deflection is between about 0.1 degrees and about 20 degrees; more preferably between about 0.1 degrees and about 10 degrees.

The terms “small-angle scattering” or “SAS” are used interchangeably herein to refer to a scattering technique based on deflection of collimated radiation away from the straight trajectory after it interacts with structures that are much larger than the wavelength of the radiation. Preferably, the angle of deflection is between about 0.1 degrees and about 20 degrees; more preferably between about 0.1 degrees and about 10 degrees.

The terms “small-angle X-ray scattering” or “SAXS” are used interchangeably herein to refer to a scattering technique using X-rays as the source of radiation. Preferably, the angle of deflection is between about 0.1 degrees and about 20 degrees; more preferably between about 0.1 degrees and about 10 degrees.

The term “transparent” as used herein refers to a material having the property of transmitting light without appreciable scattering so that bodies lying beyond are seen clearly. The term “semi-transparent” refers to a material that transmits light but does not provide a clear view of what lies beyond.

### Interfacial Deformation Assembly

Complex interfaces can exhibit both dilatational/compression stresses as well as shear stresses, and each of these types of stresses can be deformation history dependent. One of the most widely used instruments for interfacial characterization is the Langmuir trough coupled with a Wilhelmy plate. This system works by compressing the interface while simultaneously measuring the surface tension at the air-liquid or liquid-liquid interface. The Wilhelmy plate is a thin plate that is oriented perpendicular to the interface. The force on the plate due to wetting is measured using a tensiometer or microbalance. The force on the plate is used to measure the surface tension, and hence surface pressure, as a function of the surface area per molecule or particle. Dilatational or shear stress can be applied to the interface using an elastic band capable of deforming the shape and/or compressing/dilating the volume of the interface. A notable deficiency with art-standard applications of this system is that upon compression, both the shape and the area of the interface are changed or deformed, which is due to both deviatoric and isotropic stresses. Therefore, the difficulty in separating these two contributions has been a significant challenge.

To overcome this challenge, the present invention utilizes a radial Langmuir trough to enable the use of the system to independently control the pure compression/dilation of the interface as well as the pure shear of the interface. In other words, the isotropic stress response can be measured separately from the deviatoric stress response. As explained in more detail below, the combination of the radial sample trough, elastic deformation barrier, deformation arms, and motor-controlled actuator assembly enable the precise control of interfacial deformation in terms of both rate of deformation and shape of deformation. Through combining this precise control of interfacial deformation with surface pressure, reflectivity, optical, and/or particle tracking measurements, complex interfacial systems can be fully characterized on all length scales (i.e., molecular, nano, micro, and/or macro) and used along simultaneous surface pressure measurements to develop novel structure-property relationships. This is particularly useful for improving studies of complex interfaces, such as thixotropic and/or viscoelastic materials, that are sensitive to deformation history.

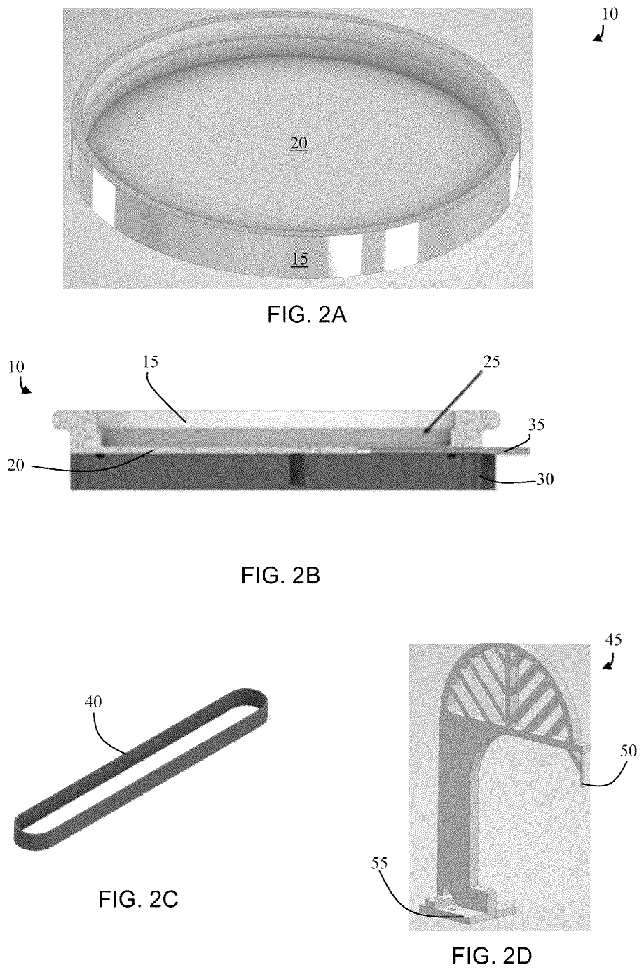

The interfacial sample is disposed in the radial sample trough for the application of stress and the rheological or metrology analysis. The radial sample trough of the instant invention may have a diameter ranging from about 100 mm to about 500 mm or more, e.g., 100 mm, 110 mm, 120 mm, 130 mm, 140 mm, 150 mm, 160 mm, 170 mm, 180 mm, 190 mm, 200 mm, 210 mm, 220 mm, 230 mm, 240 mm, 250 mm, 260 mm, 270 mm, 280 mm, 290 mm, 300 mm, 310 mm, 320 mm, 330 mm, 340 mm, 350 mm, 360 mm, 370 mm, 380 mm, 390 mm, 400 mm, 410 mm, 420 mm, 430 mm, 440 mm, 450 mm, 460 mm, 470 mm, 480 mm, 490 mm, 500 mm; preferably, the radial sample trough will have a diameter of between about 150 mm and 250 mm. For example, the exemplary radial sample trough shown in FIG. 2A has a diameter of about 210 mm. The radial sample trough will also have a circumferential side wall having a height sufficient to create a reservoir within the radial sample trough for receiving a sample. The side wall height can be from about 10 mm to about 50 mm, or more, e.g., 10 mm, 15 mm, 20 mm, 25 mm, 30 mm, 35 mm, 40 mm, 45 mm, or 50 mm. For example, the exemplary radial sample trough shown in FIG. 2A has a height of about 22.5 mm. However, as one having ordinary skill in the art will appreciate, the dimensions of the radial sample trough can be adjusted depending on the size of the environmental sample chamber needed/desired for the analysis. The sample trough will generally be constructed of a plastic material insoluble to ordinary solvents, such as, but not limited to, polytetrafluoroethylene (PTFE; TEFLON plastic), fluorinated ethylene propylene (FEP), high density polyethylene (HDPE), polyethylene terephthalate (PET), polyvinyl chloride (PVC), low density polyethylene (LDPE), polypropylene (PP), polyether ether ketone (PEEK), and the like. Alternatively, the radial sample trough may be made of glass (e.g., quartz) or non-activating metal (e.g., aluminum or titanium). In preferred embodiments, the sample trough comprises polytetrafluoroethylene.

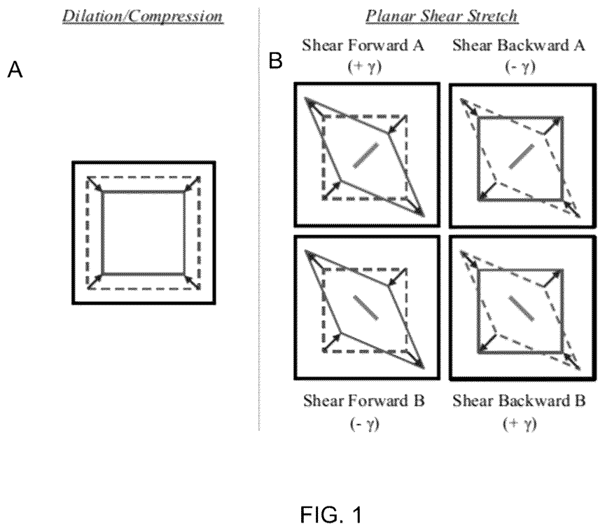

The instant invention also utilizes an elastic deformation barrier or band for deforming the interface as it applies dilation/compression and/or shear stress to the interfacial sample. In some embodiments, elastic deformation barrier applies oscillatory deformation or a superposition of compression/dilation with oscillatory deformation. The deformation of the interfacial sample is facilitated by manipulating the shape of the elastic deformation barrier using one or more deformation arms. In a preferred embodiment, four deformation arms are included that work in combination with the elastic deformation barrier to apply dilation, compression, and/or shear stress to the sample (see, for example, FIG. 5). As shown in FIG. 1A, compression stress can be applied when the arms are positioned in a quadrilateral configuration to change the elastic deformation barrier from a larger square to a smaller square. This isotropic stress changes the area of the sample interface, but not the shape, which also may be referred to as “pure compression”. The arms can also be controlled to apply planar shear stretch to the interfacial sample as shown in FIG. 1B in either a forward or backward orientation relative to a Wilhelmy plate for measuring surface tension. This deviatoric stress changes the shape of the sample interface, but not the area, which also may be referred to as “pure shear.”

The elastic deformation barrier can be made from any suitable elastic material known in the art. In preferred embodiments, the elastic deformation barrier is made from a hydrogenated elastomer or a fluoroelastomer. In particular embodiments, it may be desired to use a “neutron transparent” barrier, or a barrier that is nearly transparent to neutrons, for analysis requiring the use of neutron radiation. Elastic deformation barriers that are transparent or nearly transparent to neutrons can be achieved by using partially-fluorinated elastomers (i.e., fluoroelastomers). Elastic deformation barriers with high concentrations of fluorine content are particularly preferred when neutron radiation is to be used as opposed to hydrogenated elastomers, which may have low neutron transmission. In one particular embodiment, a hydrogenated elastomer, such as poly(styrene-butadiene-styrene) or Poly (SBS) is used. In other embodiments, fluoroelastomers are used having a fluorine content of between about 50% and about 80%, e.g., 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, or 80%; preferably, between about 60% and 75% Fluorine. In another embodiment, the Fluorine content of the fluoroelastomer is at least about 50%, or at least about 60%, or at least about 70%, or at least about 80%. In one particular embodiment, the elastic deformation barrier is made from a fluoroelastomer containing a terpolymer of vinylidene fluoride, hexafluoride, and tetrafluoroethylene is used, e.g., VITON GF-200S fluoroelastomer (The Chemours Company, Wilmington, Delaware, USA). A non-limiting, exemplary list of elastomers suitable for use herein is shown below in Table 1.

TABLE 1
Summary of physical properties of various elastic deformation barrier compositions.

| | F | | Contact | | | | | |
|---|---|---|---|---|---|---|---|---|
| | content | NT | angle | M10 | M100 | M200 | Ts | Elongation |
| Elastomer | (%) | (%) | (degrees) | (MPa) | (MPa) | (MPa) | (%) | (%) |
| Viton GF-200S | 70 | 84.9 | ~100 | 0.11 | 1.05 | 1.34 | 25 | >1,000 |
| Viton GAL- | 66 | 78.5 | 98 ± 3 | 0.12 | 0.68 | 0.88 | 23.3 | >1,000 |
| 200S | | | | | | | | |
| Viton GBL- | 68 | 81.4 | ~100 | 0.11 | 0.82 | 1.06 | 25 | >1,000 |
| 200S | | | | | | | | |
| Poly(SBS) | 0 | 31.5 | 102 ± 3 | 0.10 | 0.59 | 0.78 | 23.3 | >1,000 |

Definitions: F = Fluorine, NT = neutron transmission, Ts = tensile set, M, tensile strength at X % strain.

The combination of the elastic deformation barrier, planar sample trough, and deformation arms creates a quadrangular workable area or area of interest. The workable area ranges from about 3,000 mm² to about 15,000 mm²; preferably from about 3,500 mm² to about 12,100 mm², e.g., 3,500 mm², 3,600 mm², 3,700 mm², 3,800 mm², 3,900 mm², 4,000 mm², 4,100 mm², 4,200 mm², 4,300 mm², 4,400 mm², 4,500 mm², 4,600 mm², 4,700 mm², 4,800 mm², 4,900 mm², 5,000 mm², 5,200 mm², 5,400 mm², 5,600 mm², 5,800 mm², 6,000 mm², 6,200 mm², 6,400 mm², 6,600 mm², 6,800 mm², 7,000 mm², 7,200 mm², 7,400 mm², 7,600 mm², 7,800 mm², 8,000 mm², 8,250 mm², 8,500 mm², 8,750 mm², 9,000 mm², 9,250 mm², 9,500 mm², 9,750 mm², 10,000 mm², 10,250 mm², 10,500 mm², 10,750 mm², 11,100 mm², 11,200 mm², 11,300 mm², 11,400 mm², 11,500 mm², 11,600 mm², 11,700 mm², 11,800 mm², 11,900 mm², 12,000 mm², or 12,100 mm². The rate at which the workable area changes (i.e., the rate at which the interfacial sample is deformed) due to the movement of the deformation arms ranges from between about 1 mm²·s⁻¹ to about 150,000 mm²·s⁻¹, e.g., 1 mm²·s⁻¹, 10 mm²·s⁻¹, 20 mm²·s⁻¹, 30 mm²·s⁻¹, 40 mm²·s⁻¹, 50 mm²·s⁻¹, 60 mm²·s⁻¹, 70 mm²·s⁻¹, 80 mm²·s⁻¹, 90 mm²·s⁻¹, 100 mm²·s⁻¹, 200 mm²·s⁻¹, 300 mm²·s⁻¹, 400 mm²·s⁻¹, 500 mm²·s⁻¹, 600 mm²·s⁻¹, 700 mm²·s⁻¹, 800 mm²·s⁻¹, 900 mm²·s⁻¹, 1,000 mm²·s⁻¹, 2,000 mm²·s⁻¹, 3,000 mm²·s⁻¹, 4,000 mm²·s⁻¹, 5,000 mm²·s⁻¹, 6,000 mm²·s⁻¹, 7,000 mm²·s⁻¹, 8,000 mm²·s⁻¹, 9,000 mm²·s⁻¹, 10,000 mm²·s⁻¹, 20,000 mm²·s⁻¹, 30,000 mm²·s⁻¹, 40,000 mm²·s⁻¹, 50,000 mm²·s⁻¹, 60,000 mm²·s⁻¹, 70,000 mm²·s⁻¹, 80,000 mm²·s⁻¹, 90,000 mm²·s⁻¹, 100,000 mm²·s⁻¹, 110,000 mm²·s⁻¹, 120,000 mm²·s⁻¹, 130,000 mm²·s⁻¹, 140,000 mm²·s⁻¹, or 150,000 mm²·s⁻¹; preferably, from between about 1.02 mm²·s⁻¹ to about 146,500 mm²·s⁻¹. In one particular embodiment, the interfacial deformation assembly is capable of deforming the interfacial system at a rate of about 1.02 mm²·s⁻¹ to about 146,590 mm²·s⁻¹. It is recommended, however, that the rate be kept within the range from about 1.02 mm²·s⁻¹ to about 10 mm²·s⁻¹. The movement of the elastic deformation barrier applies a strain rate on the interfacial sample in the range from about 0.0001 s⁻¹ to about 2 s⁻¹, e.g., 0.0001 s⁻¹, 0.001 s⁻¹, 0.01 s⁻¹, 0.1 s⁻¹, 1 s⁻¹, 1.1 s⁻¹, 1.2 s⁻¹, 1.3 s⁻¹, 1.4 s⁻¹, 1.5 s⁻¹, 1.6 s⁻¹, 1.7 s⁻¹, 1.8 s⁻¹, 1.9 s⁻¹, or 2 s⁻¹. In a preferred embodiment, the applied strain rate is from about 0.00015 s⁻¹ to about 1.6 s⁻¹.

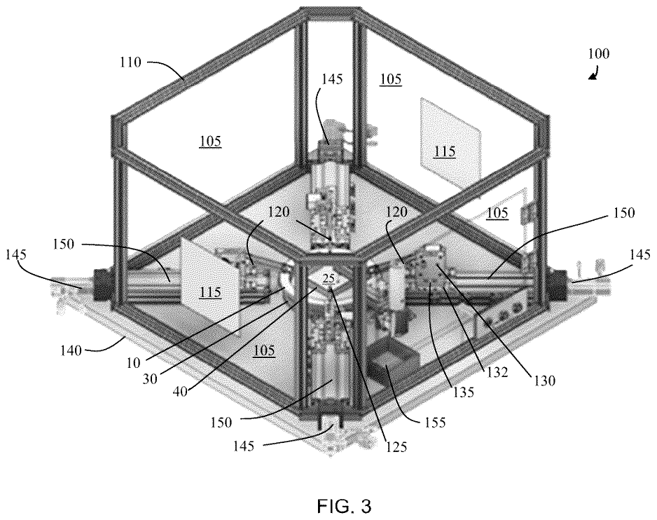

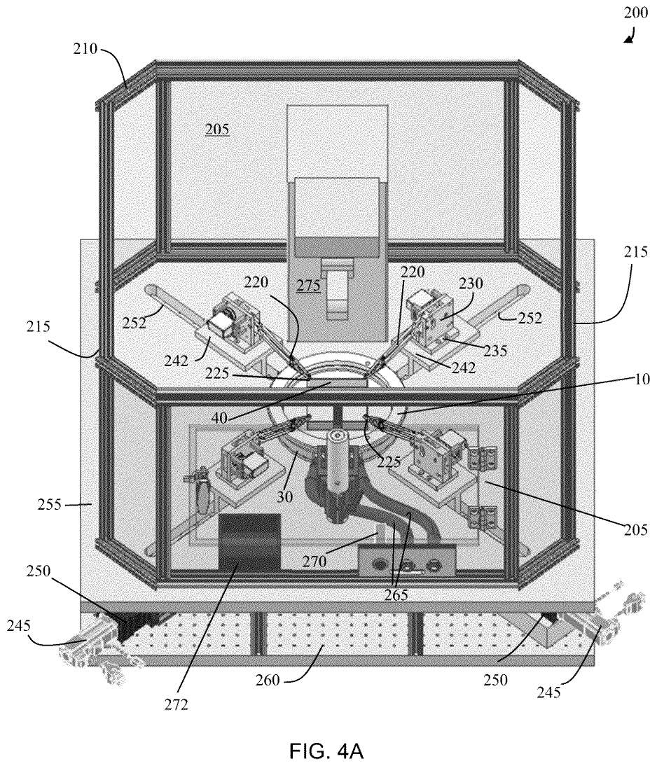

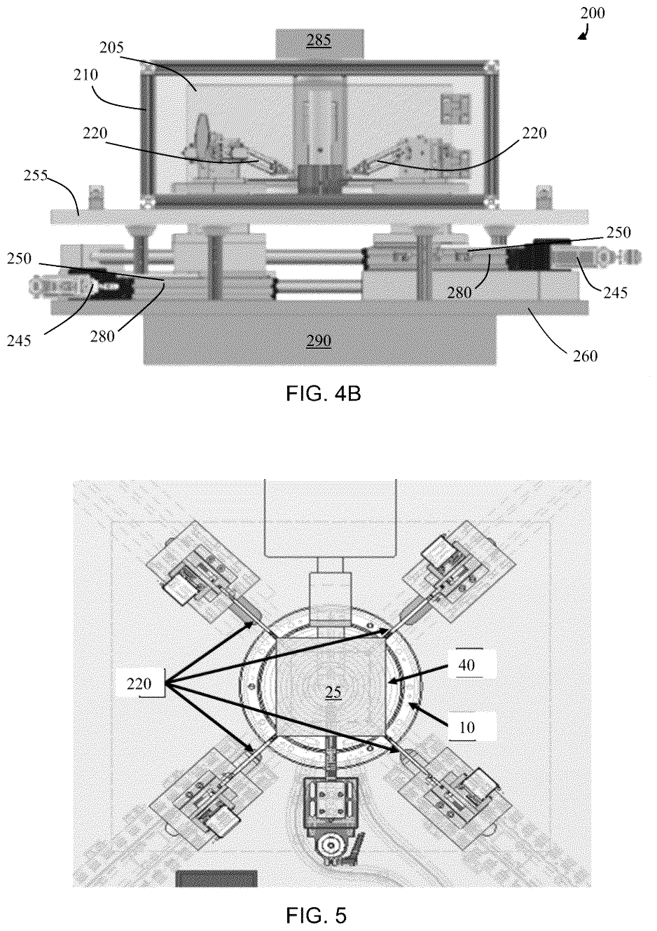

FIG. 2A depicts an exemplary radial sample trough 10. The sample trough 10 includes a circumferential side wall 15 and base that forms the sample reservoir 20. FIG. 2B is a cross-sectional view of the radial sample trough 10. The interface subphase sample 25 is disposed into the sample reservoir 20 of the sample trough 10. The sample monolayer to complete the interface is then disposed onto the subphase sample 25. The sample trough 10 can be disposed on a thermal plate 30 for circulation of heat transfer fluid for maintaining temperature control of the sample trough 10 and, in turn, the sample 25. A thermistor 35 may also be included for temperature control of the interfacial sample. To apply dilatational and/or shear, or oscillatory deformation or shear, to the interface, an elastic deformation barrier 40 is utilized (see FIG. 2C). The elastic deformation barrier 40 is deformed using one or more deformation arms. An exemplary deformation arm is shown in FIG. 2D. The deformation arm 45 includes a cylindrical finger 50 for making contact with the elastic deformation barrier 40 and an arm base 55 for connecting to a motor-controlled actuator arm (not shown). The deformation arm may be made from any suitable metal (e.g., aluminum), plastic, or composite (e.g., carbon fiber reinforced polyether ether ketone polymer used in 3D printing) material. Other shapes and sizes of deformation arms can be suitable for use, as exemplified in FIGS. 3-4B.

### Sample Environment Chamber

As noted above, the dilatational stress, shear stress, oscillatory deformation, oscillatory shear or a combination of these stresses is applied to the interfacial sample by way of deformation arms acting on the elastic deformation barrier. In a preferred embodiment, four deformation arms are included, which are moved by one or more motorized actuator arms. The radial sample trough, deformation arms, and elastic deformation barrier assembly may be disposed within a sample environment chamber for precise temperature and humidity control, and to prevent environmental contamination of the interfacial sample. The chamber frame is typically constructed of metal or plastic, and may be disposed onto a solid support or baseplate to form the sample environment chamber. The baseplate may be made of any suitable material, such as, but not limited to, plastic, wood, metal (e.g., aluminum).

The sample environment chamber will be of sufficient size to incorporate the interfacial deformation assembly and measuring instruments, such as, but not limited to, tensiometer balance and Wilhelmy plate, Brewster angle microscope, particle image velocity camera, and the like, and/or temperature/humidity control devices. In some embodiments, the motor-controlled actuator assembly is included within the interior of the sample environment chamber. Thus, the sample environment chamber may have dimensions ranging anywhere from about 10 in. to about 100 in. or more in length, e.g., 10 in., 15 in., 20 in., 25 in., 30 in., 35 in., 40 in., 45 in., 50 in., 55 in., 60 in., 65 in., 70 in., 75 in., 80 in., 85 in., 90 in., 95 in., 100 in.; about 10 in. to about 100 in. or more in width, e.g., 10 in., 15 in., 20 in., 25 in., 30 in., 35 in., 40 in., 45 in., 50 in., 55 in., 60 in., 65 in., 70 in., 75 in., 80 in., 85 in., 90 in., 95 in., 100 in.; and about 10 in. to about 50 in. or more in height, e.g., 10 in., 15 in., 20 in., 25 in., 30 in., 35 in., 40 in., 45 in., or 50 in. For instance, in one particular embodiment, the sample environment chamber has the dimensions of about 31.8×31.8×18.3 (length×width×height).

The sample environment chamber will also include paneling or walls that create an enclosed environment. The paneling or walls may be made of any suitable material, preferably at least semi-transparent and, more preferably, transparent to enable visualization of the interior of the sample environment chamber. Suitable materials include, but are not limited to, poly (methyl methacrylate), polycarbonate, and the like. Exemplary sample environment chambers are depicted in FIGS. 3, 4A, and 4B.

In some embodiments, measuring techniques may include the use of a radiation beam source, such as X-rays, optical radiation, or neutron beams. The measuring techniques may include reflectivity experiments, where the radiation is reflected off of the interface (e.g., neutron reflectivity or X-ray reflectivity), or grazing incidence methods (e.g., GISANS or GISAXS), where additional information can be obtained about the in plane structure. In certain embodiments, the radiation beam is a neutron beam created by accelerating hydrogen isotopes, e.g., deuterium, tritium, or a mixture of deuterium and tritium. In one particular embodiment, the radiation beam source is produced by a neutron velocity selector, and neutron radiation is typically passed through a collimation system to produce a parallel beam of neutron radiation to impact the interfacial sample. The impact of the neutron radiation on the interfacial sample causes scattering of the neutron radiation, which can be detected using any art-standard means, such as an 3He multidetector. In other embodiments, neutron radiation is used to perform neutron reflectivity or GISANS detection, or X-ray radiation is used to perform X-ray reflectivity or GISAXS detection. Thus, to provide an efficient pathway for the radiation beam to pass through the walls of the sample environmental chamber without causing scattering, the sample environment chamber may include one or more pairs of radiation beam windows, each of which may be comprised of a material particularly suitable for allowing radiation, such as neutron beams, to easily penetrate. Thus, materials suitable for the radiation beam windows for use with a neutron beam include, but are not limited to titanium, beryllium-quartz, aluminum, and plastic. In particular embodiments, the radiation source is a neutron beam and the radiation beam windows comprise titanium, beryllium-quartz, aluminum, or a combination of one or more of these materials. Alternatively, X-rays can be used as a source of radiation, and the radiation beam windows may be made of material optimized for X-ray passage (e.g., poly(4,4′-oxydiphenylene-pyromellitimide); KAPTON polyimide). Alternatively, optical light or laser light can be used as a source of radiation. In such an embodiment, the radiation beam windows typically would be made of optically transparent material, such as quartz glass.

The radiation beam windows will tend to have dimensions smaller than the dimensions of the side wall one which they are disposed. For instance, the dimensions of the radiation beam windows may be anywhere from about 5 in. to 9 in., e.g., 5 in., 6 in., 7 in., 8 in., or 9 in. in length; 5 in. to 9 in., e.g., 5 in., 6 in., 7 in., 8 in., or 9 in. in width; and about 0.04 in. to about 0.08 in., e.g., 0.04 in., 0.05 in., 0.06 in., 0.07 in., or 0.08 in. in thickness. In preferred embodiments, the thickness of the radiation beam windows will be less than about 0.08 in. (about 2 mm).

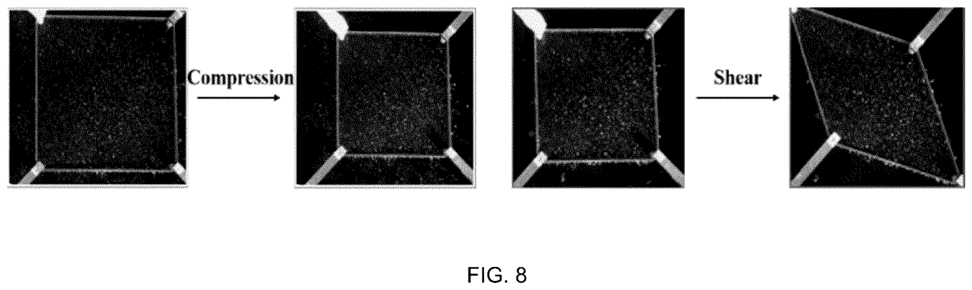

The sample environment chamber may include various characterization techniques. The tensiometer balance and Wilhelmy plate as well as neutron or X-ray reflectivity, GISANS, and GISAXS detection are discussed above. In addition, a Brewster angle microscope can be included inside the sample environment chamber to enable an interfacial structure to be visualized on a micron scale while simultaneously probing the molecular structure with neutron or X-ray reflectivity and measuring the surface moduli (see, for example, FIG. 7). A video feed of the Brewster angle microscopy viewpoint may be included in a data stream and available to monitor in real-time via the system software. Particle Image Velocimetry (PIV) involves spreading particles on the interface and recording their movement during rheological studies. PIV enables visualization of the macroscopic flow fields, which is critical for accurate rheometry. A video feed of the PIV images may be included in a data stream and available to monitor in real-time via the system software (see, for example, FIG. 8). The sample environmental chamber may also be modified for suitability with X-ray reflectivity studies of complex interfaces. This can be done by selecting different materials for the windows in the environmental chamber and the elastic deformation barrier optimal for high X-ray transmissions. Furthermore, the X-ray beamline path in air should be minimized. This can be done by using X-ray beam guides in the form of tubes, where a vacuum should be established, that lead up to interface and a second, similar tube to lead to the detector.

### Motor-Controlled Actuator Assembly and Control System

As noted above, the dilatational, shear, oscillatory deformation, and/or oscillatory shear of the interfacial sample is facilitated by manipulating the shape of the elastic deformation barrier using one or more deformation arms. In an embodiment, four deformation arms are used to manipulate the shape of the elastic deformation barrier by positioning the four deformation arms in a quadrangular arrangement. Each of the deformation arms will have a cylindrical finger around which the elastic deformation barrier is wrapped such that the combination of the deformation arms and the elastic deformation barrier has generally a quadrilateral geometry. The deformation arms, in turn, are seated on carriages that are moved linearly forward and backward by motorized actuators. The actuators are linear actuators widely available in the art and move the deformation arm carriages by way of a screw and nut configuration in response to the motor assembly. In some embodiments, the actuator arm comprises an ACME leadscrew, which moves the carriage based on sliding contact between the linear screw and nut. In a preferred embodiment, the actuator arm comprises a ball screw, which moves the carriage based on rolling contact between the linear screw and nut via ball bearings. The ball screw significantly reduces vibrations and has increased efficiency as compared to the ACME screws (70-95% compared to 20-40%). The actuator arms with the ball screw enable movement of the deformation arms to manipulate the size and/or shape of the elastic deformation barrier while reducing undesirable fluctuations at the interface that potentially compromise the accuracy of certain measurements, such as the accuracy of neutron reflectometry measurements.

The motor assembly may include a motor, such as a stepper motor or a servo motor, as well as a gearbox (e.g., planetary gearbox). The stepper motor detects the position of the stage of the motor by interpolation using 200 steps per rotation. Preferably, the actuator arms are controlled by a servo motor, which utilizes an encoder for direct reading of location data. In one embodiment, the stage position is detected by a servo motor utilizing encoder direct readout at 20,000 points per rotation. This improves the accuracy and precision of the mechanical deformation imposed on the interface, which is important for interfacial rheometry.

In one embodiment, each of the four deformation arms are moved by a separate motorized linear actuator arm. An embodiment of a quad-motor system in quadrilateral arrangement is shown in FIG. 3. The sample environment chamber 100 consists of a chamber frame 110, chamber windows 105, and a chamber baseplate 140. In this particular example, the chamber windows 105 are made from poly(methyl methacrylate), or PLEXIGLASS plastic. On opposing side windows 105 are a pair of radiation beam windows 115, which, in this embodiment, are made of aluminum at about 2 mm or less thickness. As discussed elsewhere herein, the radiation beam windows 115 are to enable efficient transmission of, e.g. neutron radiation beams, without scattering.

The sample trough 10 and thermal circulator 30 are disposed within the sample environment chamber 100. The thermal circulator 30 is connected to any art-standard fluid circulator, such as the JULABO FP35-HL circulator (Julabo USA, Inc., Pennsylvania, USA), via thermal circulation tubes (not shown). The thermal circulator 30 circulates a heat transfer fluid to facilitate heat transfer to and from the sample trough and, in turn, the sample air-fluid or fluid-fluid interface.

The sample trough 10 contains subphase reservoir 20 in which the liquid or air subphase sample 25 is disposed (see FIGS. 2A and 2B). The liquid sample monolayer is then disposed onto the subphase and surrounded by the elastic deformation barrier 40. In this particular embodiment, the elastic barrier is either a 10 mm poly(styrene-butadiene-styrene) band or a neutron invisible fluoroelastomer band. The sample environment chamber 100 also contains four deformation arms 120, each of which is connected to a linear actuator arm 150, which in turn is connected to a motor assembly 145. Each deformation arm 120 includes a cylindrical finger 125 that contacts a discreet location on the elastic deformation barrier 40. The quadrilateral configuration of the deformation arms and elastic deformation barrier can be best visualized in FIGS. 5 and 8.

The motor assembly 145 can include a stepper motor, such as the MOVTEC stepper motor capable of applying 125 N of force to the actuator arm and 30 mm*s⁻¹ max linear velocity in which location data is interpolated using 200 steps per rotation. In another embodiment, the motor assembly 145 includes a servo motor available in the art, e.g., model HGKR23 AC servo motor (Mitsubishi Electric), capable of applying 100 N of force to the actuator arm and having 36 mm*s⁻¹ max linear velocity. In a preferred embodiment, the servo motor will include an optical rotary encoder for position feedback information. The motor assembly 145 may also include a planetary gearbox for pairing with the motor. For instance, in one embodiment, the motor assembly 145 includes a servo motor paired with a planetary gearbox configuration consisting of a 50:1 stage paired with a 4:1 stage (i.e., a ratio of reduction of 200:1). In either case, the motor assembly 145 is mechanically connected to the actuator arm 150 and turns the screw element. Each deformation arm 120 is connected to the actuator carriage 132 via the arm base 135. As the motor assembly 145 turns the screw element of the actuator arm 150, the actuator carriage 132 is moved linearly forward or backward. This, in turn, moves the deformation arm 120, which manipulates the elastic deformation barrier 40. The movement of the motors is controlled by a user controlled CPU running software to enable precise movement of the motors and accurate recordation of motor location.

In this manner, the CPU-controlled motor movement enables the user to apply dilatational, compression, or shear stress to the interfacial sample via the elastic deformation barrier. Moreover, the precision control enables the application of deformation stress to the interfacial sample at regular intervals while maintaining constant surface area. For instance, the precise control of the elastic deformation barrier can be used to compress or dilate the interfacial sample at a regulatory oscillatory deformation. In some embodiments, the elastic deformation barrier can be manipulated to apply an oscillatory shear to the interfacial sample while maintaining a constant surface area. The present device can also cause the elastic deformation barrier to apply a deformation to the interfacial surface sample that is a superposition of any combination of the linear and oscillatory motions and can be dilational and/or shearing in nature. As one having ordinary skill in the art will appreciate, the superposition of the deformation refers to the combined effect of several deformation motions being applied simultaneously to the interfacial sample.

In one embodiment, the present device can apply different types of oscillatory deformation or oscillatory shear to the interfacial sample, such as, but not limited to sinusoidal, triangle wave, square wave, or other periodic function that is comprised of a superposition of multiple oscillatory frequencies. Suitable oscillatory frequencies may be in the range from about 0.001 Hz to about 1,000 Hz, e.g., 0.001 Hz, 0.002 Hz, 0.003 Hz, 0.004 Hz, 0.005 Hz, 0.006 Hz, 0.007 Hz, 0.008 Hz, 0.009 Hz, 0.010 Hz, 0.015 Hz, 0.020 Hz, 0.025 Hz, 0.030 Hz, 0.035 Hz, 0.040 Hz, 0.045 Hz, 0.050 Hz, 0.060 Hz, 0.070 Hz, 0.080 Hz, 0.090 Hz, 0.1 Hz, 0.2 Hz, 0.3 Hz, 0.4 Hz, 0.5 Hz, 0.6 Hz, 0.7 Hz, 0.8 Hz, 0.9 Hz, 1 Hz, 2 Hz, 3 Hz, 4 Hz, 5 Hz, 6 Hz, 7 Hz, 8 Hz, 9 Hz, 10 Hz, 15 Hz, 20 Hz, 25 Hz, 30 Hz, 35 Hz, 40 Hz, 45 Hz, 50 Hz, 55 Hz, 60 Hz, 65 Hz, 70 Hz, 75 Hz, 80 Hz, 85 Hz, 90 Hz, 100 Hz, 110 Hz, 120 Hz, 130 Hz, 140 Hz, 150 Hz, 160 Hz, 170 Hz, 180 Hz, 190 Hz, 200 Hz, 210 Hz, 220 Hz, 230 Hz, 240 Hz, 250 Hz, 260 Hz, 270 Hz, 280 Hz, 290 Hz, or 300 Hz; preferably, the frequency is in the range from about 0.01 Hz to about 100 Hz. Suitable strain amplitudes may be in the range from about 0.001 strain % to about 1000 strain %, e.g., 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 110%, 120%, 130%, 140%, 150%, 160%, 170%, 180%, 190%, 200%, 250%, 300%, 350%, 400%, 450%, 500%, 550%, 600%, 650%, 700%, 750%, 800%, 850%, 900, 950%, or 1,000 strain %; preferably, the strain amplitude is in the range from about 0.1 strain % to about 100 strain %.

The sample environment chamber 100 includes a humidity regulation element 155 (FIG. 3). A tensiometer balance with a Wilhelmy plate (not shown) can be disposed within the sample environment chamber 100, and the Wilhemy plate partially disposed into the sample 25. The use of the tensiometer balance and Wilhelmy plate is well within the purview of the skilled artisan. As shown in FIG. 3, the four actuator arms 150 are located within the sample environment chamber 100.

FIGS. 4A and 4B depict an alternative design comprising a dual-motor and actuator system. While the quad-motor system shown in FIG. 3 is suitable for controlling interfacial deformation, both complexity and costs may be reduced by replacing the quad-motor system with a dual-motor system. In this embodiment, each pair of actuator arms is arranged such that one actuator arm is oriented opposite the other. This can be accomplished by replacing one of the ball screws with one having a reverse thread to produce dual counter-rotating ball screw actuators. Each pair of actuator arms would then be coupled to a single motor assembly. Thus, the dual-motor design would perform the same job as the quad-motor system. This design would also allow for removing the motors from the sample environmental chamber and, therefore, remove unwanted heat and vibrations. The actuator arms would be connected to the deformation arms through slots in the chamber baseplate. The dual-motor design would also allow for minimization of the dimensions of the sample environment chamber, which would enable improved and more rapid temperature and humidity optimization and stabilization.

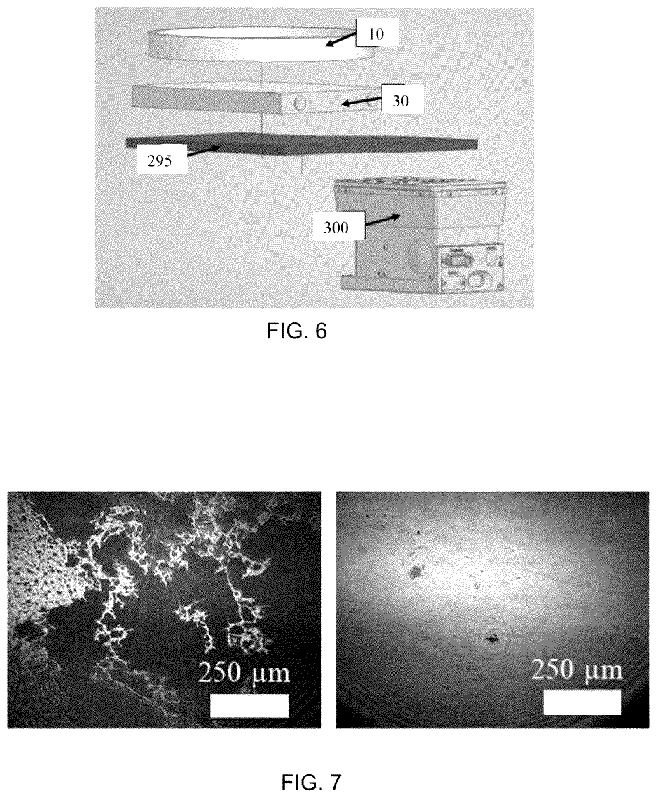

As shown in FIGS. 4A and 4B, the sample environment chamber 200 includes a chamber frame 210, chamber windows 205, and a chamber baseplate 255. The radial sample trough 10 is positioned on the thermal circulator 30, which is connected to an art-standard fluid circulator, such as the JULABO FP35-HL circulator (Julabo USA, Inc., Pennsylvania, USA), via thermal circulation tubes 265. The thermal circulator 30 equipped with the thermistor 35 is used to control the temperature of the interfacial sample. In some embodiments, a spacer plate made of suitable material (e.g., polytetrafluoroethylene) is disposed between the radial sample trough 10 and the thermal circulator 30 to minimize unwanted heat transfer (see, e.g., FIG. 6). The elastic deformation barrier 40 is wrapped around the cylindrical fingers 225 of the deformation arms 220, which are arranged in a quadrangular configuration (see also FIG. 5). Each deformation arm 220 includes a support 230 that is attached to the actuator carriage 242 by an arm base 235. For neutron reflectivity analysis, the elastic deformation barrier 40 is a 10 mm fluoroelastomer, such as the VITON GF-200S fluoroelastomer (The Chemours Company, Wilmington, Delaware, USA). Moreover, the sample environment chamber 200 includes a pair of radiation beam windows 215 made from aluminum. While, as noted above, the dimensions of the sample environment chamber can be modified for any purpose, the dimensions of the sample environment chamber 200 in FIGS. 4A and 4B is about 31.8 inches in length, about 31.8 inches in width, and about 18.32 inches in height, with the radiation beam windows being about 9 inches in length, about 7.5 inches in width, and about 0.045 inches thick.

Each deformation arm 220 is moved by an actuator arm 250 in the dual-motor arrangement shown in FIG. 4A. In this arrangement, the actuator arms 250 are positioned beneath the chamber baseplate 255 and disposed on the breadboard baseplate 260. Each pair of actuator arms 250 are arranged in the dual counter-rotating orientation and connected to a motor assembly 245 as shown in FIG. 4A. The dual-motor assemblies are arranged in a cross-pattern. Each motor assembly 245 comprises a servo motor and a planetary gearbox in a 200:1 ratio as discussed above. The motor assembly 245 rotates the ball screws 280 of the actuator arms 250 to move the deformation arms 220 in a linear direction to manipulate the elastic deformation barrier 40 and apply dilatational and/or shear stress to the interfacial sample. Since the dual-motor assemblies are positioned beneath the chamber baseplate, slots 252 are cut into the baseplate 255 to enable the connection of the actuator carriages 242 of the actuator arms 250 to the base 235 of the deformation arms 220.

As discussed above, the combination of the servo motors and ball screw design of the actuator arms enables increased accuracy and precision of the mechanical deformation imposed on the interfacial sample, which allows for more accurate interfacial rheometry measurements. Furthermore, when reviewing motors, the importance of minimal drift (i.e., linear motion when the motor should be motionless) may be considered a critical operational parameter. Therefore, while extending the elastic deformation barrier with the servo motor, the maximum error in the linear position was 1.25 μm and when holding the extended barrier at a fixed position, and there was no measurable drift observed with the encoder or with a dial indicator (resolution of 1/10000th of an inch).

The sample environment chamber 200 depicted in FIGS. 4A and 4B additionally includes a Brewster angle microscope 275 within the sample environment chamber 200 and a particle image velocity camera 285 attached to the top of the sample environment chamber 200. The purpose of these devices is known in the art and discussed above. In addition, the sample environment chamber 200 includes a temperature/humidity control sensor 270.

In some embodiments, it may be desirable to accurately control the thermodynamic state of the samples at the interface and so temperature and humidity should be well-controlled, and recorded throughout experiments. As noted above, the sample trough 10 is disposed on the thermal circulator 30, which is connected to an art-standard fluid circulator, such as the JULABO FP35-HL circulator (Julabo USA, Inc., Pennsylvania, USA), via thermal circulation tubes 265. The temperature is controlled using an operating system and software program. A thermistor is attached underneath the sample trough 10 to monitor sample temperature, and the combined temperature/humidity sensor 270 monitors and records the chamber conditions (TSP01, ThorLabs). The sample temperature quickly reaches the set value with an offset of approximately 0.5° C., which can easily be fixed by a control scheme to be implemented. The humidity may be controlled using saturated salt solutions. K₂SO₄ saturated solution (250 cm³) disposed within container 272 is suitable to maintain the relative humidity above 90%, after pre-humidifying, for at least 22 hours inside the sample environment chamber 200, and these conditions are ideal for minimizing evaporation whilst also being suitable for biological samples. If other humidities are desired, other salts can be used to achieve values between about 5% and about 98%, the selection of which is well within the purview of the skilled artisan. Addition of a Peltier heating/cooling system in the bath may be incorporated into the invention to reduce time-to-temperature and improve thermal control. Furthermore, it may reduce vibrations by reducing or even eliminating the need for the thermal circulator, thereby simplifying the instrument even further.

The temperature/humidity control element 270 enables the user to maintain the temperature within the interior of the sample environment chamber from between about 0° C. to about 100° C. with precision and accuracy. Likewise, the humidity controls enable the moisture content of the chamber interior to be maintained anywhere from about 0% relative humidity to about 100% relative humidity. Both of which can be set, modified, or maintained via the CPU.

Also shown in FIG. 4B is a vibrational isolation stage 290, which is positioned underneath the sample environment chamber 200. The purpose of the vibrational isolation stage 290 is to isolate the instrument from environmental vibrations, which potentially impact the rheological measurements. Suitable vibrational isolations stages are known in the art, for example, the TS.150/LP Tabletop system (HWL Scientific Instruments GmbH, Germany).

In some embodiments, it may be desirable to raise and lower the radial sample trough (i.e., along the vertical or Z-axis) to be able to remove it and clean it without bumping into the deformation arms. Shown in FIG. 6 is an exemplary vertical actuation stage 300 on which is disposed a spacer plate 295 made of suitable material (e.g., polytetrafluoroethylene) to minimize unwanted heat transfer, thermal circulator 30 and sample trough 10. When the user is ready to run an experiment, he or she raises the container to meet the deformation arms through the centralized graphic user interface. The vertical actuation stage 300 holds the sample container flat and steady during experiments.

In one embodiment, the motorized actuator arms are programmed to move with a constant linear velocity. This may lead to a variation in the instantaneous rate of deformation during motor motion, which is a parameter that users may desire to control. For example, the shear rate is not constant during a shear step when using a constant linear velocity. Therefore, in another embodiment, modes of motor control are employed where the motor velocity is programmed to faithfully follow a constant deformation rate that is user specified for each step. To achieve a constant rate of area change, the instantaneous rate of D is found using the following differential equation which is used in software operating system to control motor motion:

$$\frac{dD}{dt} = \frac{{C}_{1}}{D} \qquad Equation 1$$

where D is the corner-to-corner distance within the interfacial area, and C₁ is the rate of area change and t is time.

In this mode, the user is able to specify a desired area rate of change and a time or initial and final position. The second mode allows for the nominal strain to change at a constant rate and is theoretically defined in Equation 2. In this mode the user must specify the motors to be moved, the desired strain rate and a time or initial and final position. To control the strain rate (C₂), we must know how to control the ratio of the long axis of the rhombus diagonal (L) to the initial square diagonal (D). The instantaneous rate of

$$R ( R = \frac{L}{D} )$$

is calculated using the following differential equation which is used and continuously updated during movement:

$$\frac{dR}{dt} = \frac{- 4 {RC}_{2}}{{( {R}^{2} - 1 )}^{2}} \qquad Equation 2$$

Where R is ratio of the long axis of the rhombus diagonal to the initial square diagonal, C₂ is strain rate and t is time. Both of these control modes will significantly improve data quality due to rheological measurements on complex interfaces being dependent on the history of the rate of deformation as well as the total deformation.

The invention described above will include a holistic control system in communication with each of the measuring devices that the user desires to use with the sample environment chamber including the tensiometer balance and Wilhelmy plate, the Brewster angle microscope, and particle image velocimetry camera. The data captured by each device is capable of being recorded and accessible in real time in a single data stream. Moreover the control system will be in communication with the motorized actuator arms and, if it is included, the vertical actuation stage. The software for control of the instrument also includes a graphic user interphase for each of use. Finally, the invention integrates surface tension measurements and reflectivity data acquisition by enabling the user to automatically raise and lower the Wilhelmy plate so as to not interfere with neutron beam impact of the interfacial sample during reflectivity studies.

### REFERENCE NUMBERS

10—sample trough
15—side wall
20—sample reservoir
25—sample
30—thermal circulator
35—thermistor
40—elastic deformation barrier
45—deformation arm
50—finger
55—deformation arm base
100—sample environment chamber
105—chamber windows
110—chamber frame
115—radiation beam windows
120—deformation arm
125—finger
130—arm support
132—carriage
135—arm base
140—chamber baseplate
145—motor assembly
150—actuator arm
155—humidity regulation element
200—sample environment chamber
205—chamber windows
210—chamber frame
215—radiation beam windows
220—deformation arm
225—finger
230—arm support
235—arm base
240—actuator attachment
242—carriage
245—motor assembly
250—actuator arm
252—slots
255—chamber baseplate
260—breadboard baseplate
265—thermal circulation tubes
270—temperature/humidity control sensor
272—salt container
275—Brewster angle microscope
280—screw
285—particle image velocity camera
290—vibration isolation stage
295—spacer plate
300—vertical actuation stage

We claim:

1. An interfacial rheometer device comprising:
a) a sample environment chamber comprising an interior, a baseplate, and at least two radiation beam windows on opposing side walls for receiving a beam of radiation;
b) an interfacial deformation assembly comprising:
i) a radial sample trough comprising a reservoir for receiving an air-liquid or liquid-liquid interfacial sample;
ii) an elastic deformation barrier comprising an elastomer; and
iii) at least four deformation arms, each comprising a cylindrical finger,
wherein the elastic deformation barrier is disposed around the cylindrical fingers of each of the four deformation arms in a quadrangular arrangement, and wherein the interfacial deformation assembly is disposed within the interior of the sample environment chamber;
c) a motor-controlled actuator assembly comprising:
i) four actuator arms, each of which comprises a ball screw and is attached to a deformation arm and configured for moving the actuator arm in a linear direction; and
ii) at least two motors, wherein each motor is in communication with at least one actuator arm and configured for rotating the ball screw of the actuator arm;
wherein the motor-controlled actuator assembly is controlled by a central processing unit;
wherein, when in operation, the elastic deformation barrier is disposed within the reservoir of the radial sample trough and configured for applying dilatational stress, compression stress, shear stress, or any combination thereof to the interfacial sample in response to the motor-controlled actuator assembly.

2. The interfacial rheometer device of claim 1, wherein the elastic deformation barrier comprises a fluoroelastomer.

3. The interfacial rheometer device of claim 1 or claim 2, wherein the motor-controlled actuator assembly is a dual-motor system that comprises two motors, wherein the actuator arms are coupled in two pairs, with the actuator arms of each pair arranged in opposing orientations and one of each pair comprising a ball screw with reverse threads, and wherein each pair of actuator arms is connected to a motor.

4. The interfacial rheometer device of claim 1, claim 2, or claim 3, wherein each motor is a servo motor.

5. The interfacial rheometer device of any one of claims 1-4, wherein each motor is coupled to a planetary gearbox.

6. The interfacial rheometer device of any one of claims 1-5, wherein the elastic deformation barrier comprises a workable area with the range from about 3,500 mm² to about 12,100 mm².

7. The interfacial rheometer device of claim 6, wherein the elastic deformation barrier deforms the interfacial sample at a rate of between about 1.02 mm²·s⁻¹ to about 146,500 mm²·s⁻¹.

8. The interfacial rheometer device of claim 7, wherein the elastic deformation barrier deforms the interfacial sample at a rate of between about 1.02 mm²·s⁻¹ to about 10 mm²·s⁻¹.

9. The interfacial rheometer device of any one of claims 1-8, wherein the elastic deformation barrier applies strain to the interfacial sample at a strain rate from about 0.00015 s⁻¹ to about 1.6 s⁻¹.

10. The interfacial rheometer of any one of claims 1-9, wherein the elastic deformation barrier comprises at least about 60% fluorine.

11. The interfacial rheometer of any one of claims 1-10, wherein the elastic deformation barrier (i) compresses or dilates the interfacial sample at a constant rate of area change; or (ii) shears the interfacial sample while maintaining a constant surface area.

12. The interfacial rheometer of any one of claims 1-10, wherein the elastic deformation barrier: (i) compresses or dilates the interfacial sample at a regular oscillatory deformation; or (ii) applies an oscillatory shear to the interfacial sample while maintaining a constant surface area.

13. The interfacial rheometer of claim 12, wherein the oscillatory deformation or oscillatory shear is selected from the group consisting of sinusoidal, triangle wave, square wave, and superposition of multiple frequencies.

14. The interfacial rheometer of claim 12 or claim 13, wherein the oscillatory deformation or oscillatory shear comprises a frequency in the range from about 0.001 Hz to about 1000 Hz, and wherein the elastic deformation barrier applies a strain having a strain amplitude in the range from about 0.001 strain % to about 1,000 strain %.

15. The interfacial rheometer of claim 14, wherein the oscillatory deformation or oscillatory shear comprises a frequency in the range from about 0.01 Hz to about 100 Hz.

16. The interfacial rheometer of any one of claims 12-15, wherein the strain amplitude is in the range from about 0.1 strain % to about 100 strain %.

17. The interfacial rheometer of any one of claims 1-16, wherein the elastic deformation barrier applies a deformation comprising the superposition of linear motion, oscillatory motion, dilational deformation, shearing, or any combination thereof.

18. The interfacial rheometer of any one of claims 1-17, further comprising vertical actuation stage configured to move the sample trough along the Z-axis in response to the central processing unit.

19. The interfacial rheometer of any one of claims 1-18, further comprising a Brewster angle microscope disposed within the interior of the sample environment chamber and in communication with the central processing unit.

20. The interfacial rheometer of any one of claims 1-19, further comprising a particle image velocimetry camera in communication with the central processing unit.

21. The interfacial rheometer of any one of claims 1-20, further comprising a tensiometer balance and Wilhelmy plate disposed within the interior of the sample environment chamber and in communication with the central processing unit.

22. The interfacial rheometer of any one of claims 1-21, interfacing with a neutron reflectometry system configured to direct a neutron radiation beam to the interfacial sample, wherein the two radiation beam windows are aligned with the neutron radiation beam path.

23. The interfacial rheometer of any one of claims 1-22, interfacing with an X-ray system configured to direct X-ray radiation to the interfacial sample, wherein the two radiation beam windows are aligned with the X-ray radiation beam path.

24. The interfacial rheometer of claim 22 or claim 23, wherein the radiation beam windows comprise titanium, beryllium-quartz, aluminum, poly(4,4′-oxydiphenylene-pyromellitimide), or a combination thereof.

25. The interfacial rheometer of any one of claims 1-24, further comprising a temperature control device configured to maintain a temperature of the interior of the sample environment chamber to between about 0 degrees C. to about 100 degrees C. in response to the central processing unit.

26. The interfacial rheometer of any one of claims 1-25, further comprising a humidity control device configured to maintain a humidity of the interior of the sample environment chamber to between about 0% relative humidity to about 100% relative humidity in response to the central processing unit.

27. The interfacial rheometer of any one of claims 1-26, wherein the radial sample trough is disposed on a thermal circulator.

28. The interfacial rheometer of any one of claims 1-27, further comprising a vibration isolation stage disposed underneath the sample environment chamber and configured to isolate the sample from environmental vibrations.

29. A method of analyzing an interfacial sample material, comprising:
(a) providing the interfacial rheometer of any one of claims 1-28;
(b) disposing an interfacial sample in the reservoir of the radial sample trough;
(c) contacting the interfacial sample with the elastic deformation barrier;
(d) applying a strain to the interfacial sample; and
(e) measuring one or more rheological characteristics.

30. The method of claim 29, wherein the interfacial sample is an air-liquid or liquid-liquid sample.

31. The method of claim 29 or claim 30, wherein the measuring step is performed using one or more of a Brewster angle microscope to visualize the interfacial structure, a particle image velocimetry camera in combination with spreading particles for recording the particle movement during the application of stress to the interfacial structure, a Wilhelmy plate to measure surface tension of the interfacial sample, a neutron reflectometry system to neutron reflection or GISANS, an X-ray system to measure small angle X-ray reflection or GISAXS, or any combination thereof.
